(19) United States
(12) Patent Application Publication
(10) Pub. No.: US 2003/0169500 A1
(43) Pub. Date: Sep. 11, 2003

(54) Automatic glare reduction side-mirror for trucks, truck cabs and sports utility vehicles

(76) Inventor: Christopher C. Cutaia, Boonton, NJ (US)

Correspondence Address: Ernest D. Buff, Ernest D. Buff & Associates, LLC, 245 South Street, Morristown, NJ, 07960, US

(21) Appl. No.: 10/091,971

(22) Filed: Mar. 6, 2002

(51) Int. Cl. G02F 1/15; G02B 27/00; G02B 5/08; G02B 17/00

(52) U.S. Cl. 359/604; 359/265; 359/601; 359/603

(57) ABSTRACT

A side rear-view mirror for land vehicles comprises a liquid crystal cell formed by applying a liquid crystal coating over a pair of transparent conducting electrodes positioned in front of a reflecting mirror. Heating means cooperate with a temperature sensor to maintain the temperature of the liquid crystal cell substantially constant within operating limits of liquid crystals therewithin. Dimming means electrically connected to said liquid crystal cell apply dimming voltage to the liquid crystals. Insulating means encapsulate the liquid crystal cell within an envelope, thereby insulating the liquid crystals from high velocity air flow surrounding said mirror. Sensor means responsive to vehicle headlight beams impinging on said reflective element cooperate with the dimming means to increase the dimming voltage in direct proportion to impinging light intensity. The side rear-view mirror affords a greater than 90 percentile reflection, and automatic glare reduction for trucks, truck cabs and sport utility vehicles.

### BACKGROUND OF THE INVENTION

1. Field of the Invention

The present invention relates to reflective media, such as mirrors for land vehicles; and more particularly to an infinitely variable, automatic, glare reducing mirror especially suited for use as a side mirror of a truck cab, sports utility vehicle and the like.

2. Description of the Prior Art

Rear view mirrors located on the exterior of land vehicles, typically adjacent to the passenger compartment, have long been used. These mirrors perform a valuable safety function by providing information to vehicle occupants concerning the whereabouts of other moving vehicles, as well as pedestrians and stationary structures behind of the vehicle. Such information, carried by light reflected from the mirror, is frequently obscured by the intensity of the reflected light, or the formation of ice, fog, or mist on the front face of the mirror.

Attempts to improve the information carrying capacity of rear view mirrors have lead to disclosure of various glare reduction mechanisms. U.S. Pat. No. 4,371,235 to Locke Sr. discloses an image control mirror having a second reflection surface to reduce glare; but requires frequent adjustment. U.S. Pat. No. 4,560,260 to Russell discloses a side view mirror housing, secured for pivoting by a manually actuated sheathed cable to adjust its position for day/night dimming. Pressurized heated dry ambient air flows within the housing to protect the mirror from condensation, fog, snow and ice. No provision is made for automatic dimming; the Lock, Sr. device must to be manually adjusted to achieve the dimming function. U.S. Pat. Nos. 5,668,663 and 5,724,187 to Varaprasad et al., disclose electrochromic rear view mirrors for motor vehicles. Electrochromic oxide having a thickness of a few microns is sandwiched between two conducting electrodes, which inject alkali ions or protons. A redox reaction created in the conducting electrochomic oxide provides the dimming action when voltage is applied. The mirror has a sensor, which provides input for the applied dimming voltage to control the response. No disclosure is contained therein concerning use of the sensor to detect glare.

Electrochromic mirrors are constructed using a first substantially transparent substrate having a substantially transparent conductive electrode coating on its inward surface. A second substrate, which may or may not be substantially transparent, has a conductive electrode coating, which also may or may not be substantially transparent, on its inward surface. Electrochromic oxide material is placed in between the two sheets. Whether the second substrate and the conductive electrode coating thereon are or are not substantially transparent will depend on the particular construction of the mirror. When the mirror is not dimmed its transmission capability is approximately 70%. This level of transmission fails to provide a clear view. No discussion is contained by the Varaprasad et al. patents concerning the thermal characteristics of the electrochromic mirror. It is probable that that mobility of the ions under the applied voltage, and hence the dimming action of their mirror, is a function of temperature. Yet, the Varaprasad et al. mirror contains no means for stabilizing the operating temperature. Moreover, the electrochtomic “dimming capacity” is deteriorated by ultraviolet radiation. For this reason, the Varaprasad et al. patent discloses use of glass material as well as additives, which absorb the ultraviolet radiation.

U.S. Pat. Nos. 4,848,875, 4,893,902, 4,899,503, 4,964,251, 5,009,044, 5,025,602, 5,111,629, 5,152,111, 5,197,242 to Baughman, et al. disclose a dual-pane thermal window unit that comprises two nonintersecting or, preferably, substantially parallel, spaced window panes, mounted in a window frame, a first of the panes having affixed thereto a first wall of an electro-optical liquid crystal cell providing a selected light transmittance, and a second of said panes delimiting, with a second wall of said cell, a space providing a thermal break. Each of the first and second walls comprises an electrically conductive film composed of plastic and having sufficient supporting strength to maintain the structural integrity of the cell. The window is lightweight, economical to manufacture and efficient and reliable in operation. To enhance the thermal barrier effect, space between the liquid crystal cell and the second pane may be evacuated to the extent practical, or filled with an inert gas selected from the group consisting of argon, nitrogen, dry air neon and mixtures thereof. Use of an inert gas, such as nitrogen, inside of the thermal pane can be usefully employed to prevent oxidative degradation of the liquid crystal medium. The Baughman et al. patents disclose a window embodiment wherein a first of the panes has affixed thereto a first wall of an electro-optical liquid crystal cell providing a selected light transmittance. No suggestion is contained therein concerning use of a second sheet having a highly polished, light reflecting material, such as silver, chromium, or the like coated on a side thereof facing a second wall of the cell to thereby form an effective mirror. Furthermore, the Baughman, et al. patents do not disclose use of a sensor responsive to glare from vehicle headlight beams impinging on the mirror. The sensor response is used to vary the electrical conductivity of the liquid crystal film to change the opacity of the cell inversely with the strength of the impinging sunlight. Heat loss within the window system is addressed by insulating the second pane. The temperature of the liquid crystal element is maintained within the operating range by virtue of heat leakage from the house through the first pane.

Land vehicles rely primarily on the presence of side view mirrors to assess traffic flow, due to their extended length. Side view mirrors utilized with such vehicles are located laterally outward of the cab, at distance which increases directly with the vehicle's length, making them difficult to reach and adjust during driving. They are oriented to reflect light produced by objects directly behind the vehicle. Light from impinging head light beams is focused directly at the driver, causing extreme eye discomfort and glare. Conventional side view mirrors must be manually adjusted or utilize electrochromic dimming mirrors, which fail to provide a clear rear view owing to their limited (˜70%) reflectance capability in the undimmed state. Liquid crystal dimming elements have never been seriously considered for use as side rear view mirrors. The limited temperature response of liquid crystal dimming elements, and the high velocity ambient air to which vehicle side rear view mirrors are exposed, have virtually eliminated their candidacy for side rear view mirror applications.

There remains a need in the art for a side view mirror that can be located a substantial distance from the driver to provide improved rear visibility, and automatically adjusts to reduce glare caused by the impinging vehicle head light beams. Also needed is a side view mirror that provides a clear image when glare-producing conditions are absent, notwithstanding temperature changes produced by rapid movement of the vehicle, or fluctuation of ambient temperature due to climatic change.

### SUMMARY OF THE INVENTION

Our present invention provides a high response liquid crystal cell, which is thermally insulated in an enclosing cell, using vacuum or insert gas such as argon, nitrogen, neon or xenon. The liquid crystal cell is associated with means for maintaining substantially constant temperature, comprising electrical heating elements, or tubular elements, which carry ambient air from the vehicle cabin thereto. The temperature of the liquid crystal element is monitored and maintained substantially constant using a thermal sensor and control logic, which sets the heating current or the temperature and volume of heated gas flow. An insulation means is provided to minimize heat loss. The heating method utilized, as well as the quantum of heat applied, will depend upon the operating environment of the vehicle on which the side view mirrors are mounted.

The composite cell is placed in front of a highly polished reflecting mirror, so that the elements collectively provide a side view mirror function. A sensor associated with the mirror measures the amount of impinging light from vehicle headlight beams, and determines the degree of dimness required to achieve glare reduction. When the liquid crystal elements are not activated, the cell is essentially clear, providing greater than 90-percentile reflection. During dimming of the liquid crystal elements in accordance with the sensor response, glare from impinging headlight beams is reduced. In a preferred embodiment, the reflecting mirror comprises part of the electrode structure of the liquid crystal cell.

Broadly stated, the invention provides a side rear-view mirror for use in trucks, truck cabs and sports utility vehicles, comprising a reflective element means for reflecting light impinging thereon. A liquid crystal light dimming cell is disposed adjacent to the reflective element means. The liquid crystal is electrically connected to a dimming means for applying dimming voltage to liquid crystals therewithin. A heating means is provided for heating the liquid crystal cell. A control means maintains the temperature of said liquid crystal cell substantially constant, within the operating range of said liquid crystals. The liquid crystal cell is insulated from high velocity air flow surrounding said mirror by an insulation means. A sensor means is responsive to vehicle headlight beams impinging on said reflective element. The sensor means is associated with the dimming means and cooperates therewith to increase the dimming voltage in direct proportion to impinging light intensity to thereby control dimness of said liquid crystal cell.

More specifically, the invention provides a rear-view side mirror unit adapted to reduce glare in truck cab and sports utility vehicles. The unit uses a liquid crystal cell comprising two non-intersecting or, preferably, substantially parallel, spaced glass sheets mounted within a rear view mirror housing. A first of the two sheets has affixed thereto a first wall of an electro-optical liquid crystal cell providing a selected light transmittance. In one embodiment, a second of the sheets has coated on a side thereof facing a second wall of the cell, a highly polished, light reflecting material, such as silver, chromium, or the like. Each of the first and second walls comprises an electrically conductive transparent film composed of plastic or glass and having sufficient supporting strength to maintain the structural integrity of the cell. When the second of the sheets is not reflectively coated, the liquid crystal cell is placed in front of a highly reflective surface. A sensor responsive to light from vehicle headlight beams impinging on a first wall of the cell is operative to vary the electrical conductivity of the film to change the opacity of the cell inversely with the strength of the impinging light. The liquid crystal cell is provided with a heating means and temperature control logic that cooperate in combination to maintain the cell within reasonable temperature limits. The liquid crystal cell is placed within an enclosure cell, or envelope, which is evacuated or filled with inert gas such as argon, nitrogen, neon or xenon to reduce the heat flow from the liquid crystal cell to the ambient. A high velocity airflow induced by movement of the truck at speeds ranging up to 65 mph or more, quickly brings the outer temperature of the enclosure cell to ambient temperatures. The enclosure also protects the mirror from condensation of water particles during fog, accumulation of ice or snow.

### BRIEF DESCRIPTION OF DRAWINGS

The invention will be more fully understood and further advantages will become apparent when reference is had to the following detailed description and the accompanying drawings, in which:

FIG. 1 is a perspective view of an automatic glare reduction side-view mirror of the present invention, the figure showing the reflective element, liquid crystal dimming element, heating means, sensor for temperature and sensor for dimming the liquid crystal element;

FIG. 2 is a perspective view depicting a liquid crystal cell having a heating means;

FIG. 3 is a perspective view the liquid crystal cell with one electrode functioning as an integral reflective element;

FIG. 4 is a schematic diagram depicting the control circuit for maintaining a substantially constant liquid crystal cell temperature;

FIG. 5 is a schematic diagram depicting the control circuit for dimness control of liquid crystal cell.

### DESCRIPTION OF THE PREFERRED EMBODIMENTS

The present invention provides a automatic glare reduction side-mirror for trucks, truck cabs and sports utility vehicles having a construction that advantageously provides continuous dimming ability depending on the glare present and has the ability to become brighter as the glare is removed.

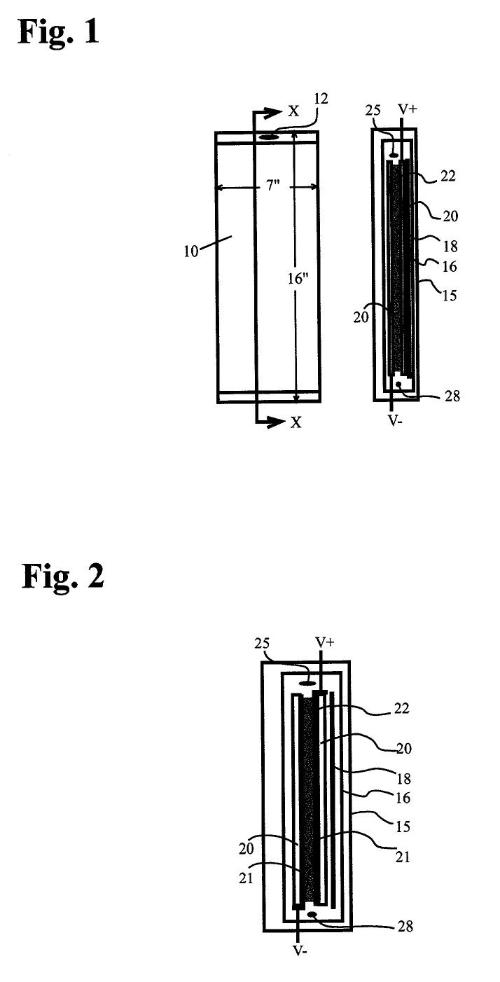

In FIG. 1 there is shown a perspective view of the side mirror constructed according to the subject invention as shown in 10. The mirror is generally 16″ tall by 7″ wide and has several elements embedded in it, as shown in the cross section XX. A liquid crystal cell with a reflective mirror at 18 is contained in 16, which is encapsulated in an envelope marked 15. The envelope can be maintained at reduced pressure or filled with inert gas including argon, nitrogen, neon or xenon or combinations thereof to minimize the heat loss from the liquid crystal cell 16. The liquid crystal cell 16 has two electrodes 20, which are conductive and make contact to the liquid crystal 22. Applying voltage to the electrodes, V+ and V− energizes the electrodes and darkens the liquid crystal element. A temperature sensor 25 monitors the temperature of the liquid crystal element and ensures proper operation of the liquid crystals by adjusting the heat provided at heating elements 28. The heating elements may be electrical resistance wires or copper tubes through which heated fluid is circulated. A control system uses the temperature sensor data to adjust the current flow through an electrical resistance heater, or moderate the flow of the heated fluid. The sensor 12 detects the glare and provides the V+/V− value through a control circuit. This sensor at 12 may be a photovoltaic device or a photo resistive device, and senses the intensity of light striking the mirror, thus adjusting the dimming level of the side view mirror. The location of the sensor is such that daylight does not dim the mirror, so that a clear view is available during daytime. Individual portions of this integral device are described hereinafter in greater detail.

Referring to FIG. 2 of the drawings, there is shown a liquid crystal cell of the invention. Liquid crystal cell 16 has two electrically conductive but transparent layers 20, which may be formed by coating a transparent glass or polymer sheet with electrically conductive transparent indium tin oxide 21. The thickness of the electro-optic liquid crystal layer 22 is typically 1 mil (1/1000 of an inch). It requires a critical voltage of 2 to 20 volts per mil, where the critical current flow disrupts the uniform alignment of the liquid crystal, causing dynamic scattering or change in pitch of helical liquid crystals or change in the orientation of dichroic dye molecules dissolved in the liquid crystal. These effects decrease the transmission of the light, creating darkening of the liquid crystal layer in response to the applied voltage. Liquid crystals can be used in different modes to reduce the transmission of light. These modes include (1) dynamic light scattering from turbulent flow of liquid crystals in an applied electric field; and (2) changes in light absorption as a consequence of application of electric field. The first effect produces grainy darkening, while the second effect, which is preferred, produces gradual uniform darkening. In the second method, one uses liquid crystals which are cholesteric and have helical structure, the pitch of which is changed by the application of an electric field. Also, orientation of monomeric or polymeric dye molecules incorporated in a liquid crystal can change the orientation of the dye molecule depending upon the applied voltage, providing dimming capability. The DC low voltage needed is applied by rectifying an AC voltage, and the applied voltage controls the degree of dimming of the liquid crystal. In FIG. 2 there is shown, a mirror 18, which reflects the light is behind the liquid crystal coating. In this embodiment, each of the electrodes for energizing the liquid crystal is transparent. Heating and temperature sensor elements are also shown by FIG. 2.

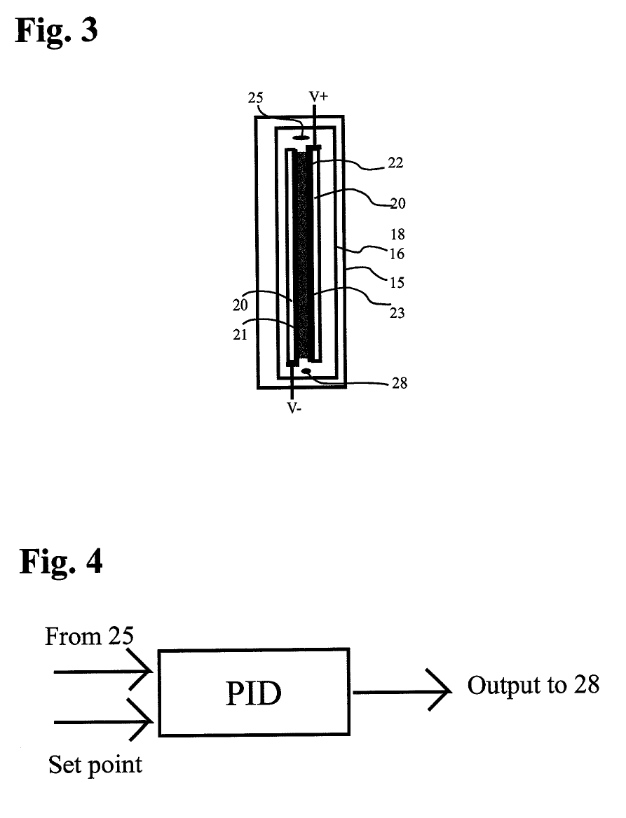

Referring to FIG. 3 of the drawings, there is shown a liquid crystal cell in which the second electrode functions as a reflector. A reflective silver, chromium or aluminum coating 23 applies the required voltage. In this configuration, there is no additional mirror behind the liquid crystal. FIG. 3 also depicts the heater and temperature sensor adapted to maintain the liquid crystal temperature within a working temperature range. The liquid crystal and conductor electrode layers are applied in the conventional way, including physical vapor deposition, spray pyrolysis and other well-known methods. Glass sheets for carrying the conductors are preferred due to its superior rigidity and ability to conduct heat compared to plastic transparent sheets of similar thickness.

FIG. 4 shows a typical control circuit for keeping the temperature of the liquid crystals substantially constant, within its operating range. The temperature measured by the sensor 25 of FIGS. 1-3 is fed as an input to a control logic, which includes proportional, integrating and differential controller (PID). The set point for the temperature is internally set as a memory number in the processor, and the output is computed based on the gain, reset and derivative values. The output of the control logic is sent as a voltage or a current signal to set the current flow in the heating elements 28 of FIGS. 1-3.

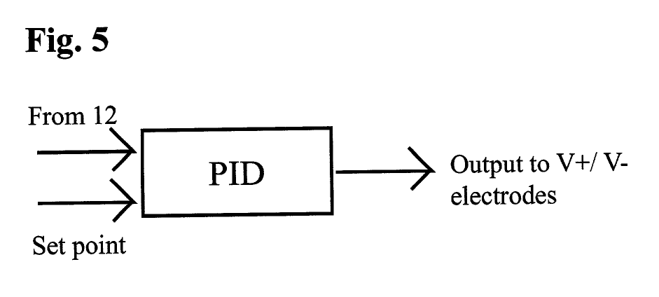

In FIG. 5 there is shown a schematic diagram of a control device for dimming the mirror 18. When light strikes sensor 12 of FIG. 1, it generates a voltage or current proportional to the intensity of glare present. This signal is fed to the PID controller. The set point is a physical voltage or current provided by a resister selectable by the driver, or may be internally generated in the memory of the processor using a program. The output of the control circuit generates a voltage, which is fed to V+ and V− terminals of the electrodes which drive the dimming function of the liquid crystal. A higher glare, as seen by the sensor 12 of FIG. 1, results in a higher V+/V− voltage, dimming the liquid crystal element to a greater degree.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A side rear-view mirror for use in trucks, truck cabs and sports utility vehicles, comprising:
a. reflective element means for reflecting light impinging thereon;
b. a liquid crystal light dimming cell disposed adjacent to said reflective element means;
c. dimming means electrically connected to said liquid crystal cell for applying dimming voltage to liquid crystals therewithin;
d. heating means for heating said liquid crystal cell;
e. control means for maintaining the temperature of said liquid crystal cell substantially constant, within the operating range of said liquid crystals;
f. insulating means for insulating said liquid crystal cell from high velocity air flow surrounding said mirror; and
g. sensor means responsive to vehicle headlight beams impinging on said reflective element and associated with said dimming means, for increasing said dimming voltage in direct proportion to impinging light intensity to thereby control dimness of said liquid crystal cell.

2. A side rear-view mirror as recited by claim 1, wherein said heating means comprises at least one electrical resistive heating element.

3. A side rear-view mirror as recited by claim 1, wherein said heating means comprises conduit means for circulating heated gas from said cabin through at least a portion of said mirror proximate said liquid crystal cell, so that said liquid crystal element is heated by said gas.

4. A side rear-view mirror as recited by claim 1, wherein said insulating means comprises an encapsulating envelope.

5. A side rear-view mirror as recited by claim 4, comprising means for maintaining said encapsulating envelope maintained at reduced pressure.

6. A side rear-view mirror as recited by claim 1, wherein said encapsulating envelope contains an inert gas for minimizing heat loss from said liquid crystal cell

7. A side rear-view mirror as recited by claim 6, wherein said inert gas is a member selected from the group consisting of argon, nitrogen, neon, xenon and mixtures thereof.

8. A side rear-view mirror as recited by claim 1, wherein said reflective element is integral with said liquid crystal cell.
